(19) United States
(12) Patent Application Publication
(10) Pub. No.: US 2013/0189587 A1
(43) Pub. Date: Jul. 25, 2013

(54) MICROPOROUS MEMBRANES, METHODS FOR MAKING SUCH MEMBRANES, AND THE USE OF SUCH MEMBRANES AS BATTERY SEPARATOR FILM

(71) Applicants: Shintaro Kikuchi, Tochigi (JP); Kazuhiro Yamada, Tochigi (JP); Junko Takita, Tochigi (JP)

(72) Inventors: Shintaro Kikuchi, Tochigi (JP); Kotaro Takita, Tochigi (JP); Kazuhiro Yamada, Tochigi (JP)

(73) Assignee: TORAY BATTERY SEPARATOR FILM CO., LTD., Nasushiobara-shi (JP)

(21) Appl. No.: 13/634,038

(22) PCT Filed: Mar. 7, 2011
(86) PCT No.: PCT/JP11/01334

§ 371 Date: Mar. 8, 2013

Related U.S. Application Data
(60) Provisional application No. 61/312,829, filed on Mar. 11, 2010.

(51) Int. Cl. H01M 2/16

(52) U.S. Cl. CPC H01M 2/1653
USPC 429/246; 429/249; 264/48

(57) ABSTRACT

The invention relates to microporous membranes having a thickness 19.0 micrometer or less, the membranes having a relatively high porosity, air permeability and puncture strength. Such membranes can be produced by extrusion and are suitable for use as battery separator film.

### TECHNICAL FIELD

The invention relates to microporous membranes having a thickness 19.0 micrometer or less, the membranes having a relatively high porosity, air permeability and puncture strength. Such membranes can be produced by extrusion and are suitable for use as battery separator film.

### BACKGROUND ART

Lithium ion batteries have a relatively large stored-energy capacity compared to batteries based on, e.g., nickel metal hydride or nickel cadmium technology. As a result of the amount of stored energy, lithium ion batteries contain battery separator film (“BSF”) that is capable of decreasing electrolyte mobility at elevated temperature. This feature, called shutdown, reduces the likelihood of catastrophic battery failure as might otherwise occur when the battery is overcharged, rapidly discharged, or suffers an internal short circuit. Since the battery's internal temperature can continue to rise even after the BSF's shutdown temperature as been reached (temperature overshoot), a relatively low BSF shutdown temperature is desirable.

Microporous polymeric membranes can be used as a BSF for separating the battery's anode and cathode. Such membranes have shutdown characteristics resulting from a decrease in electrolyte permeability through the membrane's micropores at elevated temperatures. Microporous membranes using this shutdown mechanism are widely used as BSFs in large-capacity cylindrical batteries, e.g., batteries used for power tools, and notebook computers. Such batteries generally use thick separators (generally 20.0 micrometer or more), e.g., for increased strength in severe service.

Lower-capacity prismatic lithium ion batteries are generally used in applications where small size is desired, such as in mobile telephones. Such batteries use relatively thin BSF, e.g., 19.0 micrometer or less. Such batteries can use an alternative method for preventing catastrophic failure during overcharge conditions as described in U.S. Patent Application Publication No. US2006/0281007.

During battery overcharge, a large overcharge current releases lithium from the active material on the battery's positive electrode and destroys the crystallinity of the electrode's active material (e.g., LiCoO₂). The crystallinity loss is exothermic, which can result in significantly higher battery temperature, leading to battery failure. The patent publication discloses that the released lithium forms short circuits (e.g., micro-shorts) between the battery's anode and cathode, which shunt a portion of the overcharge current and lessens the risk of battery failure. Since the short circuit paths are relatively long (compared to their cross-sectional area), providing a relatively high resistance per unit length, the battery gradually discharges to remove the overcharge condition. This considerably lessens the risk of catastrophic battery failure. Higher porosity BSFs are desired for increasing the separator surface area available for lithium deposit, and, consequently, increasing the amount of overcharge current shunted through the BSF. High-porosity microporous membranes have been produced, using, e.g., inorganic pore-forming species, but these membranes generally have a lower pin puncture strength than low-porosity membranes of the same thickness.

### CITATION LIST

### Patent Literature

U.S. Patent Application Publication No. US2006/0281007

### SUMMARY OF INVENTION

### Technical Problem

There is therefore a need for high-porosity, high-strength microporous membranes having a thickness 19.0 micrometer or less.

### Solution to Problem

In an embodiment, the invention relates to a membrane comprising polymer, the membrane having a thickness 19.0 micrometer or less, a porosity 43.0% or more, a puncture strength 1.7×10² mN/micrometer or more, and a normalized air permeability 10.0 or less seconds/100 cm³/micrometer, wherein the membrane is microporous.

In another embodiment, the invention relates to a method for producing a microporous membrane, comprising:
(1) extruding a mixture of diluent and 24.0 wt. % or less polymer based on the weight of the mixture, the polymer comprising an amount A₁ of a first polymer and an amount A₂ of a second polymer, wherein the first polymer has an Mw less than 1.0×10⁶, the second polymer has an Mw 1.0×10⁶ or more, A₁ is in the range of from 55.0 wt. % to 75.0 wt. %, and A₂ is in the range of from 25.0 wt. % to 45.0 wt. %, the A₁ and A₂ weight percents being based on the weight of the polymer in the mixture;
(2) stretching the extrudate in at least a first direction;
(3) removing at least a portion of the diluent from the stretched extrudate to produce a membrane; and
(4) stretching the membrane in at least a second direction to a magnification factor 1.15 or more to achieve a membrane thickness 19.0 micrometer or less.

In yet another embodiment, the invention relates to a battery comprising an electrolyte, an anode, a cathode, and a separator situated between the anode and the cathode, wherein the separator comprises the membrane of the preceding example.

### Advantageous Effects of Invention

The microporous membranes of the present invention having a thickness 19.0 micrometer or less, have a relatively high porosity, air permeability and puncture strength.

### DESCRIPTION OF EMBODIMENTS

Microporous membranes have been produced by extruding a mixture of diluent and polymer blend, stretching the extrudate (upstream stretching), and removing at least a portion of the diluent from the stretched extrudate. When increased porosity and puncture strength is desired, the membrane can be stretched after diluent removal (downstream stretching). It has been observed that high porosity membranes having a thickness 19.0 micrometer or less tear during downstream stretching before the puncture strength and porosity targets can be achieved.

The invention is based on the discovery of microporous membranes having a thickness 19.0 micrometer or less, a porosity 43.0% or more, a puncture strength 1.7×10² mN/micrometer or more, and a normalized air permeability 10.0 seconds/100 cm³/micrometer or less. Such membranes have sufficient strength and permeability to be useful as BSFs in prismatic lithium ion batteries and have a pore structure compatible with the formation of lithium deposits on the membrane's internal pore surfaces to alleviate battery overcharge conditions. It has been discovered that such membranes can be produced by extruding a mixture comprising diluent and a polymer blend provided (i) the mixture contains 24.0 wt. % or less of the polymer blend based on the weight of the mixture; and (ii) the amount of polymer in the polymer blend having a weight average molecular weight (“Mw”) 1.0×10⁶ or more is 25.0 wt. % or more based on the weight of the polymer blend.

While not wishing to be bound by any theory or model, it is believed that the membrane's puncture strength and porosity targets can be achieved by maintaining the relative amount of polymer chain entanglements in approximately the same range as is the case for membranes having lower porosity and a thickness 20.0 micrometer or more. It has been observed that increasing the amount of polymer having an Mw 1.0×10⁶ or more generally increases chain entanglement, but decreasing the amount of polymer in the polymer-diluent mixture to 24.0 wt. % or less reduces the number of polymer entanglements into a range that prevents film tearing during downstream stretching.

Selected embodiments will now be described in more detail, but this description is not meant to foreclose other embodiments within the broader scope of this disclosure. For the purpose of this description and the appended claims, the term “polymer” means a composition including a plurality of macromolecules, the macromolecules containing recurring units derived from one or more monomers. The macromolecules can have different size, molecular architecture, atomic content, etc. The term “polymer” includes macromolecules such as copolymer, terpolymer, etc. “Polyethylene” means polyolefin containing 50% or more (by number) recurring ethylene-derived units, preferably polyethylene homopolymer and/or polyethylene copolymer wherein at least 85% (by number) of the recurring units are ethylene units. A “microporous membrane” is a thin film having pores, where 90.0 percent or more (by volume) of the film's pore volume resides in pores having average diameters in the range of 0.01 micrometer to 10.0 micrometer. With respect to membranes produced from extrudates, the machine direction (“MD”) is defined as the direction in which an extrudate is produced from a die. The transverse direction (“TD”) is defined as the direction perpendicular to both MD and the thickness direction of the extrudate. MD and TD can be referred to as planar directions of the membrane, where the term “planar” in this context means a direction lying substantially in the plane of the membrane when the membrane is flat.

### Membrane Composition

In an embodiment, the membrane is microporous and comprises polymer. The membrane has a thickness 19.0 micrometer or less, a porosity 43.0% or more, a puncture strength 1.7×10² mN/micrometer or more, and a normalized air permeability 10.0 seconds/100 cm³/micrometer or less. The polymer can comprise, for example, a first polymer having an Mw less than 1.0×10⁶ and a second polymer having an Mw 1.0×10⁶ or more. In an embodiment, the first polymer is present in the membrane in an amount 75.0 wt. % or less and the second polymer is present in an amount 25.0 wt. % or more, the weight percents being based on the weight of the membrane. Optionally, the amount of first polymer is in the range of 55.0 wt. % to 75.0 wt. % and the amount of second polymer is in the range of 25.0 wt. % to 45.0 wt. %, the weight percents being based on the weight of the membrane.

In an embodiment, the polymer can comprise polyolefin, such as polyethylene. For example, the first polymer optionally comprises a first polyethylene and the second polymer comprises a second polyethylene. Optionally, the first polyethylene has an Mw in the range of 4.0×10⁵ to 6.0×10⁵ and a molecular weight distribution (“MWD”, defined as Mw divided by the number average molecular weight) in the range of 3.0 to 10.0. Optionally, the second polyethylene has an Mw in the range of 1.0×10⁶ to 3.0×10⁶ and an MWD in the range of 4.0 to 15.0. Optionally, first polyethylene has an amount of terminal unsaturation 0.14 or less per 1.0×10⁴ carbon atoms.

In an embodiment, the membrane has a 105 degrees Celsius TD heat shrinkage 1.0% or less and a Maximum TMA TD heat shrinkage 10.0% or less. Optionally, the membrane has a porosity 45.0% or more, a puncture strength 1.85×10² mN/micrometer or more, a TD tensile strength 1.×10⁵ kPa or less, and a thickness 17.5 micron or less.

### Particular Embodiment

In one embodiment, the microporous membrane comprising polyethylene has a thickness 19.0 micrometer or less, a porosity 43.0% or more, a puncture strength 1.7×10² mN/micrometer or more, and a normalized air permeability 10.0 seconds/100 cm³/micrometer or less. For example, the membrane can comprise (a) 55.0 wt. % to 75.0 wt. % of the first polyethylene, such as 68.0 to 72.0 wt. % of the first polyethylene; and (b) 25.0 wt. % to 45.0 wt. % of the second polyethylene, such as 28.0 wt. % to 32.0 wt. % of the second polyethylene; the weight percents being based on the weight of the membrane, wherein (i) the first polyethylene has an Mw in the range of 4.0×10⁵ to 6.0×10⁵, an MWD in the range of 3.0 to 10.0, a melting point 132 degrees Celsius or more, and an amount of terminal unsaturation in the range of 0.05 per 1.0×10⁴ carbon atoms to 0.14 per 1.0×10⁴ carbon atoms; and (ii) the second polyethylene has an Mw of from 1.0×10⁶ to 3.0×10⁶, an MWD in the range of 4.0 to 15.0, and a melting point 134 degrees Celsius or more. Optionally, the membrane contains 10.0 wt. % or less of inorganic material, based on the weight of the membrane. Optionally, the first polyethylene, the second polyethylene, and the polypropylene together comprise 95.0 wt. % or more, e.g., 98.0 wt. % or more, such as 99.0 wt. % or more of the membrane, based on the total weight of the membrane.

Such a membrane can have a thickness 19.0 micrometer or less, such as in the range of 14.0 micrometer to 18.0 micrometer; a porosity 43.0% or more, such as in the range of 45.0% to 55.0%; a normalized air permeability 10.0 seconds/100 cm³/micrometer or less, such as in the range of 5.0 seconds/100 cm³/micrometer to 9.50 seconds/100 cm³/micrometer; a normalized pin puncture strength 1.7×10² mN/micrometer or more, such as in the range of 1.7×10² mN/micrometer to 2.5×10² mN/micrometer; a TD tensile strength 1.1×10⁵ kPa or less, such as in the range of 5.0×10⁴ kPa to 1.0×10⁵ kPa; an MD tensile strength 8.0×10⁴ kPa or more, such as in the range of 1.2×10⁵ kPa to 2.0×10⁵ kPa; a 105 degrees Celsius TD Heat Shrinkage 0.5% or less, such as in the range of 0.01% to 0.5%; a 105 degrees Celsius MD Heat Shrinkage 10.0% or less, such as in the range of 0.5% to 10.0%; a Maximum TMA TD Heat Shrinkage 10.0% or less, such as in the range of 1.0% to −10.0%; a Maximum TMA MD Heat Shrinkage 25.0% or less, such as in the range of 1.0% to 10.0%; a shutdown temperature 135.0 degrees Celsius or less; and a meltdown temperature 140.0 degrees Celsius or more.

The polymers of the microporous membrane will now be described in more detail.

### Polyethylene

In particular embodiments, the polyethylene (“PE”) can comprise a mixture or reactor blend of polyethylene, such as a mixture of the first and second polyethylenes. The polyethylenes will now be described in more detail.

### First Polyethylene

In an embodiment, the first PE includes, e.g., a PE having an Mw less than 1.0×10⁶, e.g., in the range of about 1.0×10⁵ to about 0.90×10⁶; an MWD 50.0 or less, e.g., in the range of about 2.0 to about 50.0; and a terminal unsaturation amount less than 0.20 per 1.0×10⁴ carbon atoms (PE1). Optionally, PE1 has an Mw in the range of about 4.0×10⁵ to about 6.0×10⁵, and an MWD of about 3.0 to about 10.0. Optionally, PE1 has an amount of terminal unsaturation 0.14 or less per 1.0×10⁴ carbon atoms, or 0.12 or less per 1.0×10⁴ carbon atoms, e.g., in the range of 0.05 to 0.14 per 1.0×10⁴ carbon atoms (e.g., below the detection limit of the measurement).

In another embodiment, the first PE includes, e.g., PE having an Mw less than 1.0×10⁶, e.g., in the range of about 2.0×10⁵ to about 0.9×10⁶, an MWD 50.0 or less, e.g., in the range of about 2 to about 50, and a terminal unsaturation amount 0.20 or more per 1.0×10⁴ carbon atoms (PE2). Optionally, PE2 has an amount of terminal unsaturation 0.30 or more per 1.0×10⁴ carbon atoms, or 0.50 or more per 1.0×10⁴ carbon atoms, e.g., in the range of 0.6 to 10.0 per 1.0×10⁴ carbon atoms. A non-limiting example of PE2 is one having an Mw in the range of about 3.0×10⁵ to about 8.0×10⁵, for example about 7.5×10⁵, and an MWD of from about 4 to about 15. PE1 and/or PE2 can be, e.g., an ethylene homopolymer or an ethylene/alpha-olefin copolymer containing 5.0 mole % or less of one or more comonomer such as alpha-olefin, based on 100% by mole of the copolymer. Optionally, the alpha-olefin is one or more of propylene, butene-1, pentene-1, hexene-1,4-methylpentene-1, octene-1, vinyl acetate, methyl methacrylate, or styrene. Such a PE can have a melting point 132 degrees Celsius or more. PE1 can be produced, e.g., in a process using a Ziegler-Natta or single-site polymerization catalyst, but this is not required. The amount of terminal unsaturation can be measured in accordance with the procedures described in PCT Publication WO 97/23554, for example. PE2 can be produced using a chromium-containing catalyst, for example. In an embodiment, the first polyethylene does not include a significant amount of PE2, e.g., the first polyethylene comprises 0.1 wt. % or less PE2 based on the weight of the first polyethylene. For example, in an embodiment, the first polyethylene consists of or consists essentially of PE1.

When a membrane having a relatively low shutdown temperature is desired, the first polyethylene can include, e.g., a PE having a Tm 130.0 degrees Celsius or less. Such a polyethylene can provide the finished membrane with a shutdown temperature 130.5 degrees Celsius or less.

### Second Polyethylene

In an embodiment, the second polyethylene can include, e.g., PE having an Mw 1.0×10⁶ or more, e.g., in the range of about 1.0×10⁶ to about 5.0×10⁶ and an MWD of about 1.2 to about 50.0 (PE3). A non-limiting example of PE3 is one having an Mw of about 1.0×10⁶ to about 3.0×10⁶, for example about 2.0×10⁶, and an MWD 20.0 or less, e.g., of about 2.0 to about 20.0, preferably about 4.0 to about 15.0. PE3 can include, e.g., an ethylene homopolymer or an ethylene/alpha-olefin copolymer containing 5.0 mole % or less of one or more comonomers such as alpha-olefin, based on 100% by mole of the copolymer. The comonomer can be, for example, one or more of, propylene, butene-1, pentene-1, hexene-1,4-methylpentene-1, octene-1, vinyl acetate, methyl methacrylate, or styrene. Such a polymer or copolymer can be produced using a Ziegler-Natta or a single-site catalyst, though this is not required. Such a PE can have a melting point 134 degrees Celsius or more.

The melting point, of the first and second polyethylenes can be determined using the methods similar to those disclosed in PCT Patent Publication No. WO2008/140835, for example. Mw and MWD of the polyethylenes are determined using a High Temperature Size Exclusion Chromatograph, or “SEC”, (GPC PL 220, Polymer Laboratories), equipped with a differential refractive index detector (DRI). Three PLgel Mixed-B columns (available from Polymer Laboratories) are used. The nominal flow rate is 0.5 cm³/min, and the nominal injection volume is 300 micro L. Transfer lines, columns, and the DRI detector were contained in an oven maintained at 145 degrees Celsius. The measurement is made in accordance with the procedure disclosed in “Macromolecules, Vol. 34, No. 19, pp. 6812-6820 (2001)”.

The GPC solvent used is filtered Aldrich reagent grade 1,2,4-Trichlorobenzene (TCB) containing approximately 1000 ppm of butylated hydroxy toluene (BHT). The TCB is degassed with an online degasser prior to introduction into the SEC. Polymer solutions are prepared by placing dry polymer in a glass container, adding the desired amount of the above TCB solvent, then heating the mixture at 160 degrees Celsius with continuous agitation for about 2 hours. The concentration of UHMWPE solution was 0.25 to 0.75 mg/ml. Sample solution is filtered off-line before injecting to GPC with 2 micrometer filter using a model SP260 Sample Prep Station (available from Polymer Laboratories).

The separation efficiency of the column set is calibrated with a calibration curve generated using a seventeen individual polystyrene standards ranging in Mp (“Mp” being defined as the peak in Mw) from about 580 to about 10,000,000. The polystyrene standards are obtained from Polymer Laboratories (Amherst, Mass.). A calibration curve (logMp vs. retention volume) is generated by recording the retention volume at the peak in the DRI signal for each PS standard and fitting this data set to a 2nd-order polynomial. Samples are analyzed using IGOR Pro, available from Wave Metrics, Inc.

### Other Species

Optionally, inorganic species (such as species containing silicon and/or aluminum atoms), and/or heat-resistant polymers such as those described in PCT Publications WO 2007/132942 and WO 2008/016174 (both of which are incorporated by reference herein in their entirety) can be present in the membrane. In an embodiment, the membrane contains 10.0 wt. % or less of such materials, e.g., 1.0 wt. % or less, based on the weight of the membrane.

A small amount of diluent or other species, e.g., as processing aids, can also be present in the membrane, generally in amounts less than 1.0 wt. % based on the weight of the membrane.

When the microporous membrane is produced by extrusion, the final microporous membrane generally comprises the polymer used to produce the extrudate. A small amount of polymer molecular weight degradation might occur during processing, but this is acceptable. In an embodiment, molecular weight degradation during processing, if any, causes the value of MWD of the polymer in the membrane to differ from the MWD of the polymer used to produce the membrane (e.g., before extrusion) by no more than, e.g., about 10%, or no more than about 1%, or no more than about 0.1%.

Methods for producing the microporous membranes will now be described in more detail. While the invention is described in terms of a monolayer membrane produced by extrusion, the invention is not limited thereto, and this description is not meant to foreclose other embodiments within the broader scope of the invention.

### Membrane Production Method

In one or more embodiments, the microporous membranes can be produced by combining PE1 and/or PE2 with PE3 (e.g., by dry blending or melt mixing) with diluent and optional constituents such as inorganic fillers to form a mixture and then extruding the mixture to form an extrudate. At least a portion of the diluent is removed from the extrudate to form the microporous membrane. For example, a blend of PE can be combined with diluent such as liquid paraffin to form a mixture, with the mixture being extruded to form a monolayer membrane. Additional layers can be applied to the extrudate, if desired, e.g., to provide the finished membrane with a low shutdown functionality. In other words, monolayer extrudates or monolayer microporous membranes can be laminated or coextruded to form multilayered membranes.

The process for producing the membrane further comprises stretching the extrudate in at least one planar direction before diluent removal, and stretching the membrane in at least one planar direction after diluent removal. The process for producing the membrane optionally further comprises steps for, e.g., removing at least a portion of any remaining volatile species from the membrane at any time after diluent removal, subjecting the membrane to a thermal treatment (such as heat setting or annealing) before or after diluent removal. An optional hot solvent treatment step, an optional heat setting step, an optional cross-linking step with ionizing radiation, and an optional hydrophilic treatment step, etc., as described in PCT Publication WO 2008/016174 can be conducted if desired. Neither the number nor order of the optional steps is critical.

### Producing the Polymer-Diluent Mixture

In one or more embodiments first and second polymers (as described above, e.g., PE1 (and/or PE2) and PE3) are combined to form a polymer blend and the blend is combined with diluent (which can be a mixture of diluents, e.g., a solvent mixture) to produce a polymer-diluent mixture. Mixing can be conducted in, e.g., in an extruder such as a reaction extruder. Such extruders include, without limitation, twin-screw extruders, ring extruders, and planetary extruders. Practice of the invention is not limited to the type of extruder employed. Optional species can be included in the polymer-diluent mixture, e.g., fillers, antioxidants, stabilizers, and/or heat-resistant polymers. The type and amounts of such optional species can be the same as described in PCT Publications WO 2007/132942, WO 2008/016174, and WO 2008/140835, all of which are incorporated by reference herein in their entirety.

The diluent is generally compatible with the polymers used to produce the extrudate. For example, the diluent can be any species or combination of species capable of forming a single phase in conjunction with the resin at the extrusion temperature. Examples of the diluent include one or more of aliphatic or cyclic hydrocarbon such as nonane, decane, decalin and paraffin oil, and phthalic acid ester such as dibutyl phthalate and dioctyl phthalate. Paraffin oil with a kinetic viscosity of 20-200 cSt at 40 degrees Celsius can be used, for example. The diluent can be the same as those described in U.S. Patent Publication Nos. 2008/0057388 and 2008/0057389, both of which are incorporated by reference in their entirety.

In an embodiment, the blended polymer in the polymer-diluent mixture comprises an amount A₁ of the first polymer (e.g., PE1) and an amount A₂ of the second polymer (e.g., PE3), wherein the polymer-diluent mixture comprises 24.0 wt. % or less polymer based on the weight of the mixture. In an embodiment, the first polymer has an Mw less than 1.0×10⁶, the second polymer has an Mw 1.0×10⁶ or more, A₁ is in the range of from 55.0 wt. % to 75.0 wt. %, and A₂ is in the range of from 25.0 wt. % to 45.0 wt. %, the A₁ and A₂ weight percents being based on the weight of the polymer in the mixture. Optionally, A₁ is in the range of from 65.0 wt. % to 75.0 wt. %, e.g., in the range of from 68.0 wt. % to 72.0 wt. %. Optionally, A₂ is in the range of from 25.0 wt. % to 35.0 wt. %, e.g., in the range of from 28.0 wt. % to 32.0 wt. %.

In an embodiment, the polymer-diluent mixture during extrusion is exposed to a temperature in the range of 140 degrees Celsius to 250 degrees Celsius, e.g., 210 degrees Celsius to 230 degrees Celsius. In an embodiment, the amount of polymer used to produce the extrudate is in the range, e.g., of from 20.0 wt. % to 24.0 wt. % based on the weight of the polymer-diluent mixture, with the balance being diluent. For example, the amount of polymer can be in the range of about 20.0 wt. % to about 23.5 wt. %.

### Producing the Extrudate

In an embodiment, the polymer-diluent mixture is conducted from an extruder through a die to produce the extrudate. The extrudate should have an appropriate thickness to produce, after the stretching steps, a final membrane having the desired thickness (generally 1.0 micrometer or more). For example, the extrudate can have a thickness in the range of about 0.1 mm to about 10.0 mm, or about 0.5 mm to 5 mm. The thickness of the extrudate is not critical, and is selected to provide a finished membrane having a final membrane thickness (after downstream stretching) 19.0 micrometer or less.

Extrusion is generally conducted with the polymer-diluent mixture in the molten state. When a sheet-forming die is used, the die lip is generally heated to an elevated temperature, e.g., in the range of about 140 degrees Celsius to about 250 degrees Celsius. Suitable process conditions for accomplishing the extrusion are disclosed in PCT Publications WO 2007/132942 and WO 2008/016174.

If desired, the extrudate can be exposed to a temperature in the range of about 10 degrees Celsius to about 45 degrees Celsius to form a cooled extrudate. Cooling rate is not critical. For example, the extrudate can be cooled at a cooling rate of at least about 30 degrees Celsius/minute until the temperature of the extrudate (the cooled temperature) is approximately equal to the extrudate's gelation temperature (or lower). Process conditions for cooling can be the same as those disclosed in PCT Publications No. WO 2007/132942; WO 2008/016174; and WO 2008/140835; for example.

### Stretching the Extrudate (Upstream Stretching)

The extrudate or cooled extrudate can be stretched in at least one direction, e.g., in a planar direction such as MD or TD. It is believed that such stretching results in at least some orientation of the polymer in the extrudate. This orientation is referred to as “upstream” orientation. The extrudate can be stretched by, for example, a tenter method, a roll method, an inflation method or a combination thereof, as described in PCT Publication No. WO 2008/016174, for example. The stretching may be conducted monoaxially or biaxially, though the biaxial stretching is preferable. In the case of biaxial stretching, any of simultaneous biaxial stretching, sequential stretching or multi-stage stretching (for instance, a combination of the simultaneous biaxial stretching and the sequential stretching) can be used, though simultaneous biaxial stretching is preferable. When biaxial stretching is used, the amount of magnification need not be the same in each stretching direction.

The stretching magnification can be, for example, 2 fold or more, optionally 3 to 30 fold in the case of monoaxial stretching. In the case of biaxial stretching, the stretching magnification can be, for example, 3 fold or more in any direction, namely 9 fold or more, such as 16 fold or more, e.g., 20 fold or more, in area magnification. An example for this stretching step would include stretching from about 9 fold to about 49 fold in area magnification. Again, the amount of stretch in either direction need not be the same. The magnification factor operates multiplicatively on film size. For example, a film having an initial width (TD) of 2.0 cm that is stretched in TD to a magnification factor of 4 fold will have a final width of 8.0 cm.

The stretching can be conducted while exposing the extrudate to a temperature (the upstream stretching temperature) in the range of about the Tcd temperature to Tm, where Tcd and Tm are defined as the crystal dispersion temperature and melting point of the PE having the lowest melting point among the polyethylenes used to produce the extrudate (generally the PE such as PE1 or PE2). The crystal dispersion temperature is determined by measuring the temperature characteristics of dynamic viscoelasticity according to ASTM D 4065. In an embodiment where Tcd is in the range of about 90 degrees Celsius to about 100 degrees Celsius, the upstream stretching temperature can be from 90.0 degrees Celsius to 122.0 degrees Celsius; e.g., about 110.0 degrees Celsius to 120.0 degrees Celsius, such as 113.0 degrees Celsius to 117.0 degrees Celsius.

When the sample (e.g., the extrudate, dried extrudate, membrane, etc.) is exposed to an elevated temperature, this exposure can be accomplished by heating air and then conveying the heated air into proximity with the sample. The temperature of the heated air, which is generally controlled at a set point equal to the desired temperature, is then conducted toward the sample through a plenum for example. Other methods for exposing the sample to an elevated temperature, including conventional methods such as exposing the sample to a heated surface, infrared heating in an oven, etc., can be used with or instead of heated air.

### Diluent Removal

In an embodiment, at least a portion of the diluent is removed (or displaced) from the stretched extrudate to form a dried membrane. A displacing (or “washing”) solvent can be used to remove (wash away, or displace) the diluent, as described in PCT Publication No. WO 2008/016174, for example.

In an embodiment, at least a portion of any remaining volatile species (e.g., washing solvent) is removed from the dried membrane after diluent removal. Any method capable of removing the washing solvent can be used, including conventional methods such as heat-drying, wind-drying (moving air), etc. Process conditions for removing volatile species such as washing solvent can be the same as those disclosed in PCT Publication No. WO 2008/016174, for example.

### Stretching the Membrane (Downstream Stretching)

The dried membrane can be stretched (called “downstream stretching” or “dry stretching” since at least a portion of the diluent has been removed or displaced) in at least one direction, e.g., MD and/or TD. The downstream stretching can be conducted to, e.g., a magnification factor 1.2 or more. It is believed that such stretching results in at least some orientation of the polymer in the membrane. This orientation is referred to as downstream orientation. Before dry stretching, the dried membrane has an initial size in MD (a first dry length) and an initial size in TD (a first dry width). As used herein, the term “first dry width” refers to the size of the dried membrane in TD prior to the start of dry orientation. The term “first dry length” refers to the size of the dried membrane in MD prior to the start of dry orientation. Tenter stretching equipment of the kind described in WO 2008/016174 can be used, for example.

The dried membrane can be stretched in MD from the first dry length to a second dry length that is larger than the first dry length by a magnification factor (the “MD dry stretching magnification factor”) in the range of about 1.0 to about 1.6, e.g., in the range of 1.1 to 1.5. When TD dry stretching is used, the dried membrane can be stretched in TD from the first dry width to a second dry width that is larger than the first dry width by a magnification factor (the “TD dry stretching magnification factor”). Optionally, the TD dry stretching magnification factor is less than or equal to the MD dry stretching magnification factor.

In an embodiment, the TD dry stretching magnification factor is 1.15 or more, or 1.2 or more, e.g., can be in the range of 1.15 to 1.6, such as about 1.2 to about 1.5. The dry stretching (also called re-stretching since the diluent-containing extrudate has already been stretched) can be sequential or simultaneous in MD and TD. When biaxial dry stretching is used, the dry stretching can be simultaneous in MD and TD or sequential. When the dry stretching is sequential, generally MD stretching is conducted first, followed by TD stretching.

The dry stretching can be conducted while exposing the dried membrane to a temperature (the downstream stretching temperature) less than or equal to Tm, e.g., in the range of about Tcd-20 degrees Celsius to Tm. In an embodiment, the downstream stretching temperature is in the range of about 70.0 degrees Celsius to about 135.0 degrees Celsius, for example about 110.0 degrees Celsius to about 132.0 degrees Celsius, such as about 120.0 degrees Celsius to about 124.0 degrees Celsius.

In a embodiment, the MD stretching magnification is about 1.0; the TD dry stretching magnification is 1.6 or less, e.g. in the range of from about 1.1 to about 1.5, such as about 1.2 to about 1.5; and the downstream stretching temperature is in the range of about 120 degrees Celsius to about 124 degrees Celsius.

The stretching rate is preferably 3%/second or more in the stretching direction (MD or TD), and the rate can be independently selected for MD and TD stretching. The stretching rate is preferably 5%/second or more, more preferably 10%/second or more, e.g., in the range of 5%/second to 25%/second. The upper limit of the stretching rate is optionally 50%/second to prevent rupture of the membrane.

### Controlled Reduction of the Membrane's Width

Following the dry stretching, the dried membrane can be subjected to a controlled reduction in width from the second dry width to a third dry width, the third dry width being in the range of 0.9 times the first dry width to about 1.5 times larger than the first dry width. Optionally, the second dry width is in the range of 1.25 times to 1.35 times of the first dry width and the third dry width is in the range of 0.95 times to 1.05 times of the first dry width. The width reduction generally conducted while the membrane is exposed to a temperature Ted −30 degrees Celsius or more, but no greater than Tm, e.g., in the range of about 70.0 degrees Celsius to about 135.0 degrees Celsius, for example about 110.0 degrees Celsius to about 132.0 degrees Celsius, such as about 120.0 degrees Celsius to about 124.0 degrees Celsius.

Although the temperature during controlled width reduction can be the same as the downstream stretching temperature, this is not required, and in one embodiment the temperature to which the membrane is exposed during controlled width reduction is 1.01 times or more the downstream stretching temperature, e.g., in the range of 1.05 times to 1.1 times. In an embodiment, the decreasing of the membrane's width is conducted while the membrane is exposed to a temperature that 124.0 degrees Celsius or less, the third dry width is in the range of 0.95 times to 1.05 times of the first dry width.

### Heat Set

Optionally, the membrane is thermally treated (e.g., heat-set) at least once following diluent removal, e.g., after dry stretching, the controlled width reduction, or both. It is believed that heat-setting stabilizes crystals and makes uniform lamellas in the membrane. In an embodiment, the heat setting is conducted while exposing the membrane to a temperature in the range Tcd to Tm, e.g., in the range of about 70.0 degrees Celsius to about 135.0 degrees Celsius, for example about 110.0 degrees Celsius to about 132.0 degrees Celsius, such as about 120.0 degrees Celsius to about 124.0 degrees Celsius. Although the heat set temperature can be the same as the downstream stretching temperature, this is not required. In one embodiment the temperature to which the membrane is exposed during heat setting is 1.01 times or more the downstream stretching temperature, e.g., in the range of 1.05 times to 1.1 times. Generally, the heat setting is conducted for a time sufficient to form uniform lamellas in the membrane, e.g., a time 1000 seconds or less, e.g., in the range of 1 to 600 seconds. In an embodiment, the heat setting is operated under conventional heat-set “thermal fixation” conditions. The term “thermal fixation” refers to heat-setting carried out while maintaining the length and width of the membrane substantially constant, e.g., by holding the membrane's perimeter with tenter clips during the heat setting.

Optionally, an annealing treatment can be conducted after the heat-set step. The annealing is a heat treatment with no load applied to the membrane, and can be conducted by using, e.g., a heating chamber with a belt conveyer or an air-floating-type heating chamber. The annealing may also be conducted continuously after the heat-setting with the tenter slackened. During annealing, the membrane can be exposed to a temperature in the range of Tm or lower, e.g., in the range of about 60 degrees Celsius to about Tm −5 degrees Celsius. Annealing is believed to provide the microporous membrane with improved permeability and strength.

Optional heated roller, hot solvent, crosslinking, hydrophilizing, and coating treatments can be conducted, if desired, e.g., as described in PCT Publication No. WO 2008/016174.

### Membrane Properties

The membrane is microporous membrane that is permeable to liquid (aqueous and non-aqueous) at atmospheric pressure. Thus, the membrane can be used as a battery separator, filtration membrane, etc. The thermoplastic film is particularly useful as a BSF for a secondary battery, such as a nickel-hydrogen battery, nickel-cadmium battery, nickel-zinc battery, silver-zinc battery, lithium-ion battery, lithium-ion polymer battery, etc. In an embodiment, the invention relates to lithium-ion secondary batteries containing BSF comprising the thermoplastic film. Such batteries are described in PCT Patent Publication WO 2008/016174, which is incorporated herein by reference in its entirety. The membrane can have one or more of the following properties.

### Thickness

In an embodiment, the thickness of the final membrane is 19.0 micrometer or less, e.g., 18.0 micrometer or less, such as 17.5 micrometer or less. Optionally, the membrane has a thickness in the range of about 1.0 micrometer to about 18.5 micrometer, e.g., in the range of about 14.0 micrometer to about 18.0 micrometer. The membrane's thickness can be measured, e.g., by a contact thickness meter at 1 cm longitudinal intervals over the width of 10 cm, and then averaged to yield the membrane thickness. Thickness meters such as a Model RC-1 Rotary Caliper, available from Maysun, Inc., 746-3 Gokanjima, Fuji City, Shizuoka, Japan 416-0946 or a “Litematic” available from Mitsutoyo Corporation, are suitable. Non-contact thickness measurement methods are also suitable, e.g., optical thickness measurement methods.

### Porosity

The membrane's porosity is measured conventionally by comparing the membrane's actual weight to the weight of an equivalent non-porous membrane of 100% polymer (equivalent in the sense of having the same polymer composition, length, width, and thickness). Porosity is then determined using the formula: Porosity %=100×(w2−w1)/w2, where “w 1” is the actual weight of the membrane, and “w2” is the weight of an equivalent non-porous membrane (of the same polymers) having the same size and thickness. In an embodiment, the membrane's porosity is 43.0% or more, e.g., in the range of about 45.0% to about 55.0%.

### Normalized Air Permeability

In an embodiment, the membrane has a normalized air permeability which is 10.0 seconds/100 cm³/micrometer or less, e.g., in the range of about 1.0 seconds/100 cm³/micrometer to about 10.0 seconds/100 cm³/micrometer, such as about 2.0 seconds/100 cm³/micrometer to about 9.0 seconds/100 cm³/micrometer. Since the air permeability value is normalized to the value for an equivalent membrane having a film thickness of 1.0 micrometer, the membrane's air permeability value is expressed in units of “seconds/100 cm³/micrometer”. Normalized air permeability is measured according to JIS P 8117, and the results are normalized to the permeability value of an equivalent membrane having a thickness of 1.0 micrometer using the equation A=1.0 micrometer*(X)/T₁, where X is the measured air permeability of a membrane having an actual thickness T₁ and A is the normalized air permeability of an equivalent membrane having a thickness of 1.0 micrometer.

### Normalized Pin Puncture Strength

The membrane's pin puncture strength is expressed as the pin puncture strength of an equivalent membrane having a thickness of 1.0 micrometer and a porosity of 50% and is expressed in units of [mN/micrometer]. Pin puncture strength is defined as the maximum load measured at ambient temperature when the membrane having a thickness of T₁ is pricked with a needle of 1 mm in diameter with a spherical end surface (radius R of curvature: 0.5 mm) at a speed of 2 mm/second. The pin puncture strength (“S”) is normalized to the pin puncture strength value of an equivalent membrane having a thickness of 1.0 micrometer and a porosity of 50% using the equation S₂=[50%*10 micrometer*(S₁)]/[T₁*(100%−P)], where S₁ is the measured pin puncture strength, S₂ is the normalized pin puncture strength, P is the membrane's measured porosity, and T₁ is the average thickness of the membrane. In an embodiment, the membrane's normalized pin puncture strength is 1.7×10² mN/micrometer or more. Optionally, the membrane's normalized pin puncture strength is 1.8×10² mN/micrometer or more, e.g., 2.0×10² mN/micrometer or more, such as in the range of 1.7×10² mN/micrometer to 2.5×10² mN/micrometer.

### Tensile Strength

In an embodiment, the membrane has an MD tensile strength 7.5×10⁴ kPa or more, e.g., in the range of 8.0×10⁴ to 2.5×10⁵ kPa, and a TD tensile strength 1.5×10⁵ kPa or less, such as 1.10×10⁵ kPa or less, e.g., in the range of 5.0×10⁴ kPa to 1.0×10⁵ kPa. Tensile strength can be measured in MD and TD according to ASTM D-882A. Tensile elongation is measured according to ASTM D-882A. In an embodiment, the membrane's MD and TD tensile elongation are each 100% or more, e.g., in the range of 125% to 350%. In another embodiment, the membrane's MD tensile elongation is in the range of, e.g., 125% to 250% and TD tensile elongation is in the range of, e.g., about 140% to about 300%. 105 degrees Celsius Heat Shrinkage

In an embodiment, the membrane has a TD heat shrinkage at 105 degrees Celsius which is 7.5% or less, e.g., 5.0% or less, such as 0.5% or less. In an embodiment, the membrane's 105.0 degrees Celsius TD heat shrinkage is in the range of about 0.01% to about 1.0%. Optionally, the membrane has a 105 degrees Celsius MD heat shrinkage 10.0% or less, e.g., in the range of about 0.5% to about 10.0%.

The membrane's heat shrinkage in orthogonal directions (e.g., the planar direction MD or TD) at 105.0 degrees Celsius (the “105 degrees Celsius heat shrinkage”) is measured as follows: (i) measure the size of a test piece of microporous membrane at 23.0 degrees Celsius in both MD and TD; (ii) expose the test piece to a temperature of 105.0 degrees Celsius for 8 hours with no applied load; and then (iii) measure the size of the membrane in both MD and TD. The heat (or “thermal”) shrinkage in either the MD or TD can be obtained by dividing the result of measurement (i) by the result of measurement; and (ii) expressing the resulting quotient as a percent.

### Maximum TMA Heat Shrinkage

Maximum TMA Heat Shrinkage in a planar direction of the membrane (e.g., MD and/or TD) is measured by the following procedure.

For Maximum TD Heat Shrinkage, a rectangular sample of about 3.0 mm×about 50.0 mm is cut out of the microporous membrane such that the long axis of the sample is aligned with the microporous membrane's TD and the short axis is aligned with MD. The sample is set in the thermomechanical analyzer (TMA/SS6000 available from Seiko Instruments, Inc.) at a chuck distance of 10.0 mm, i.e., the distance from the upper chuck to the lower chuck is 10.0 mm, with the long axis of the sample aligned with the chuck-chuck axis of the TMA analyzer. The lower chuck is fixed and a load of 19.6 mN applied to the sample at the upper chuck. The chucks and sample are enclosed in a tube which can be heated. Starting at 30.0 degrees Celsius, the temperature inside the tube is elevated at a rate of 5 degrees Celsius/minute. The sample length change under the 19.6 mN load is measured at intervals of 0.5 second and recorded as temperature is increased from 135 degrees Celsius to 145 degrees Celsius. The maximum TMA heat shrinkage is defined as the sample length between the chucks measured at 23 degrees Celsius (L1 equal to 10.0 mm) minus the minimum length measured generally in the range of about 135 degrees Celsius to about 145 degrees Celsius (equal to L2) divided by L1, i.e., W1−L21/L1*100%. A negative heat shrinkage value corresponds to membrane expansion. When MD maximum TMA heat shrinkage is measured, the rectangular sample of about 3.0 mm×about 50.0 mm used is cut out of the microporous membrane such that the long axis of the sample is aligned with MD of the microporous membrane as it is produced in the process and the short axis is aligned with TD.

In an embodiment, the membrane's Maximum TD heat shrinkage is 10.0% or less, or 1.0% or less, or −1.0% or less, e.g., in the range of 5.0% to −15.0%, or about 1.0% to about −10.0%. In an embodiment, the membrane's Maximum MD heat shrinkage in the molten state is 25.0% or less, or 20.0% or less, or 10.0% or less, e.g., in the range of about 1.0% to about 10.0%.

### EXAMPLE

This invention will be described in more detail with reference to Examples below. The invention is not limited to the exemplified embodiment, and the examples are not meant to foreclose other embodiments within the broader scope of the invention.

### Example 1

This Example demonstrates that a microporous membrane having a thickness 19.0 micrometer or less can be produced, the membrane having a porosity 43.0% or more, a puncture strength 1.7×10² mN/micrometer or more, and a normalized air permeability 10.0 seconds/100 cm³/micrometer or less. A polymer-diluent mixture is prepared by combining (a) 70.0 wt. % of polyethylene having an Mw of 5.6×10⁵, an MWD of 4.1, and having a terminal unsaturation amount of 0.1 per 1.0×10⁴ carbon atoms (the first polyethylene, identified as PE1) with (b) 30.0 wt. % of polyethylene having an Mw of 2.0×10⁶ and an MWD of 5 (the second polyethylene, identified as PE3), the weight percents being based on the weight of the polymer.

23.0 wt. % of the combined PE1 and PE3 are mixed in a strong-blending, double-screw extruder with 77.0 wt. % of liquid paraffin (50 cSt at 40 degrees Celsius), the weight percents being based on the weight of the mixture. Mixing is conducted at 210 degrees Celsius, and the mixture is extruded from a T-die connected to the double-screw extruder. The extrudate is cooled by contacting with cooling rolls having a temperature controlled at about 40 degrees Celsius, to form a cooled extrudate. Using a tenter-stretching machine, the extrudate (in the form of a gel-like sheet) is simultaneously biaxially stretched (upstream stretching) while exposing the extrudate to a temperature of 115.0 degrees Celsius (the upstream stretching temperature) to an upstream stretching magnification factor of 5-fold in both MD and TD (i.e., the total area magnification is 25). The stretched extrudate is then heat set by exposing it to a temperature of 95.0 degrees Celsius. The heat-set extrudate is then immersed in a bath of methylene chloride controlled at 25 degrees Celsius (to remove the liquid paraffin) for 3 minutes while keeping the length and width of the extrudate fixed, and dried by an air flow at 25.0 degrees Celsius. The dried extrudate is then dry-stretched (downstream stretching) in TD to a downstream stretching magnification of 1.3 while exposing the membrane to a temperature of 122.2 degrees Celsius (the downstream stretching temperature), and then subjected to a controlled reduction in width to a final magnification factor of 1.0 (i.e., the membrane's width after controlled width reduction is approximately the same as the membrane's width at the start of downstream stretching. The membrane is then heat set for ten minutes. The downstream stretching, controlled width reduction, and heat setting are conducted while exposing the membrane to substantially the same temperature, in this case a temperature of 122.2 degrees Celsius. Selected process conditions are summarized in the table. Membrane thickness, permeability, strength, and heat shrinkage are measured and the results summarized in Table 1.

### Example 2

Example 1 is repeated except as specified in the table, e.g., the membrane of Example 2 is subjected to downstream stretching to a magnification factor of 1.4, but is not subjected to a controlled width reduction after downstream orientation.

In Comparative Example 1, PE2 having an Mw of 7.5×10⁵ and an amount of terminal unsaturation more than 0.20 per 1.0×10⁴ carbon atoms is used instead of PE1.

As shown in Table 1, Examples 1 and 2 demonstrate that a microporous membrane having a thickness 19.0 micrometer or less can be produced, the membrane having a porosity 43.0% or more, a puncture strength 1.7×10² mN/micrometer or more, and a normalized air permeability 10.0 seconds/100 cm³/micrometer or less. Comparative Example 1 shows that it is more difficult to achieve the desired porosity and permeability when PE2 is substituted for PE1, even when the amount of polymer in the polymer-diluent mixture is 23 wt. % based on the weight of the mixture. Comparative Examples 2 and 3 show that it is more difficult to achieve the desired air permeability value even when PE1 is used when the amount of polymer in the polymer-diluent mixture is more than 24.0 wt. % based on the weight of the mixture. Reducing the relative amount of PE3 in the polymer-diluent mixture leads to increased porosity, but membrane pin puncture strength is worsened as shown by Comparative Example 4. Comparative Example 5 shows that although pin puncture strength can be recovered by increasing the amount of polymer in the polymer-diluent mixture, this change results in worsened permeability and porosity. Selected membrane properties shown in the table as a “-” in connection with a particular example or comparative example are not measured. Starting materials shown as “- -” in the table in connection with a particular example or comparative example are not used.

TABLE 1

| | | | Comparative | Comparative | Comparative | Comparative | Comparative |
|---|---|---|---|---|---|---|---|
| | Example 1 | Example 2 | Example 1 | Example 2 | Example 3 | Example 4 | Example 5 |
| Starting Materials: | | | | | | | |
| PE3 (wt %) | 30 | 30 | 30 | 40 | 30 | 18 | 2 |
| PE2 (wt %) | — | — | 70 | — | — | — | — |
| PE1 (wt %) | 70 | 70 | — | 60 | 70 | 82 | 98 |
| Process Conditions | | | | | | | |
| Polymer content in | 23.0 | 23.0 | 23.0 | 25.0 | 25.0 | 25.0 | 39.0 |
| polymer-diluent mixture | | | | | | | |
| (wt %) | | | | | | | |
| Upstream Stretching Temp. (° C.) | 115.0/95.0 | 118.0/95 | 116.5/95 | 115.0/95.0 | 115.0/95.0 | 118.0/95.0 | 118.7/95.0 |
| Heat Set Temperature (° C.) | 122.2 | 126.9 | 124.2 | 124.5 | 126.0 | 126.2 | 130.2 |
| Downstream stretching | 1.3 → 1.0 | 1.4 | 1.10 → 0.95 | 1.08→ 0.96 | .95 | 1.4 | 1.4 |
| Magnification | | | | | | | |
| Properties | | | | | | | |
| Average Thickness | 16 | 16 | 16 | 16 | 20 | 20 | 19 |
| (μm) | | | | | | | |
| Normalized air permeability | 9.38 | 5.63 | 21.9 | 16.3 | 18.0 | 5.0 | 12.0 |
| Porosity | 46 | 48 | 35 | 44 | 39 | 52 | 39 |
| Normalized puncture strength | 189.9 | 171.5 | 177.6 | 245.0 | 235.2 | 147.0 | 230.3 |
| (mN/μm) | | | | | | | |
| Tensile-MD (kPa) | 1.23 × 10⁵ | 8.34 × 10⁴ | 1.23 × 10⁵ | 1.52 × 10⁵ | 1.27 × 10⁵ | 6.9 × 10⁴ | 1.13 × 10⁵ |
| Tensile - TD (kPa) | 8.34 × 10⁴ | 8.83 × 10⁴ | 8.83 × 10⁴ | 1.13 × 10⁵ | 9.81 × 10⁴ | 7.85 × 10⁴ | 1.62 × 10⁵ |
| 105° C. MD Heat Shrinkage (%) | 7.5 | 4.0 | 5.0 | 9.0 | 6.5 | 4.5 | 2.5 |
| 105° C. TD Heat Shrinkage (%) | 0.5 | 5.0 | 1.0 | 2.5 | 3.0 | 5.0 | 2.5 |
| Max MD Heat Shrinkage (%) | 19 | 3 | 19 | — | — | — | 15 |
| Max TD Heat Shrinkage (%) | −8 | 9 | −9 | — | — | 12 | 38 |

All patents, test procedures, and other documents cited herein, including priority documents, are fully incorporated by reference to the extent such disclosure is not inconsistent and for all jurisdictions in which such incorporation is permitted.

While the illustrative forms disclosed herein have been described with particularity, it will be understood that various other modifications will be apparent to and can be readily made by those skilled in the art without departing from the spirit and scope of the disclosure. Accordingly, it is not intended that the scope of the claims appended hereto be limited to the examples and descriptions set forth herein but rather that the claims be construed as encompassing all the features of patentable novelty which reside herein, including all features which would be treated as equivalents thereof by those skilled in the art to which this disclosure pertains.

When numerical lower limits and numerical upper limits are listed herein, ranges from any lower limit to any upper limit are contemplated.

### INDUSTRIAL APPLICABILITY

The microporous membranes of the present invention are suitable for use as battery separator film.

1. A membrane comprising a polymer and having a thickness of 19.0 micrometer or less, a porosity of 43.0% or more, a puncture strength of 1.7×10² mN/micrometer or more, and a normalized air permeability of 10.0 seconds/100 cm³/micrometer or less, wherein the membrane is microporous.

2. The membrane of claim 1, wherein the polymer comprises a first polymer having an Mw less than 1.0×10⁶ and a second polymer having an Mw 1.0×10⁶ or more.

3. The membrane of claim 1, wherein the membrane has a 105 degrees Celsius TD heat shrinkage of 5.0% or less and a maximum TMA TD heat shrinkage of 10.0% or less.

4. The membrane of claim 1, having a porosity of 45% or more, a puncture strength of 185 mN/micrometer or more, a TD tensile strength of 1.10×10⁵ kPa or less, and a thickness of 17.5 micron or less.

5. The membrane of claim 2, wherein the first polymer is present in an amount of 75.0 wt. % or less and the second polymer is present in an amount of 25.0 wt. % or more, the weight percents being based on the weight of the membrane, and the first polymer comprises a first polyethylene, the second polymer comprises a second polyethylene.

6. (canceled)

7. The membrane of claim 5, wherein the first polyethylene has an Mw 4.0×10⁵ to 6.0×10⁵ and an MWD of 3.0 to 10.0, and the second polyethylene has an Mw of 1.0×10⁶ to 3.0×10⁶ and an MWD of 4.0 to 15.0.

8. (canceled)

9. The membrane of claim 5, wherein the first polyethylene has an amount of terminal unsaturation of 0.14 or less per 1.0×10⁴ carbon atoms.

10. A battery separator comprising the membrane of claim 1.

11. A method for producing a microporous membrane, comprising:
(1) forming an extrudate by extruding a mixture of diluent and 24.0 wt. % or less of polymer based on the weight of the mixture, the polymer comprising an amount A₁ of a first polymer and an amount A₂ of a second polymer, wherein the first polymer has an Mw less than 1.0×10⁶, the second polymer has an Mw of 1.0×10⁶ or more, A₁ is in an amount of 55.0 wt. % to 75.0 wt. %, and A₂ is in an amount of 25.0 wt. % to 45.0 wt. %, the A₁ and A₂ weight percents being based on the weight of the polymer in the mixture;
(2) stretching the extrudate in at least a first direction;
(3) removing at least a portion of the diluent from the stretched extrudate to produce a membrane; and
(4) stretching the membrane in at least a second direction to a magnification factor of 1.15 or more to achieve a membrane thickness of 19.0 micrometer or less.

12. (canceled)

13. (canceled)

14. The method of claim 11, wherein the extrudate stretching is conducted to achieve an area magnification factor of 20.0 or more while exposing the extrudate to a temperature of 90.0 degrees Celsius to 122.0 degrees Celsius.

15. (canceled)

16. The method of claim 11, wherein the membrane stretching is conducted to achieve a magnification factor of 1.2 or more and wherein the method further comprises reducing the size of the membrane in a second planar direction.

17. The method of claim 16, wherein the first and second directions are TD.

18. The method of claim 11, wherein the first polymer is a first polyethylene, the second polymer is a second polyethylene, the first polyethylene has an Mw of 4.0×10⁵ to 6.0×10⁵ and an MWD of 3.0 to 10.0, and the second polyethylene has an Mw of 1.0×10⁶ to 3.0×10⁶ and an MWD of 4.0 to 15.0.

19. The method of claim 18, wherein the first polyethylene has an amount of terminal unsaturation of 0.14 or less per 1.0×10⁴ carbon atoms.

20. The membrane product of claim 11.

21. A battery comprising an electrolyte, an anode, a cathode, and a separator situated between the anode and the cathode, wherein the separator comprises the membrane of claim 1.

22. The battery of claim 21, wherein the polymer comprises 75.0 wt. % or less of a first polymer and 25.0 wt. % or more of a second polymer, the weight percents based on the weight of the membrane, wherein the first polymer has an Mw less than 1.0×10⁶ and the second polymer has an Mw of 1.0×10⁶ or more.

23. The battery of claim 21, wherein the first polymer is a first polyethylene, the second polymer is a second polyethylene, the first polyethylene has an Mw of 4.0×10⁵ to 6.0×10⁵ and an MWD of 3.0 to 10.0, and the second polyethylene has an Mw of 1.0×10⁶ to 3.0×10⁶ and an MWD of 4.0 to 15.0.

24. The battery of claim 23, wherein the first polyethylene has an amount of terminal unsaturation of 0.14 or less per 1.0×10⁴ carbon atoms, and wherein the microporous membrane comprises 10.0 wt. % or less inorganic material based on the weight of the membrane.

25. The battery of claim 24, wherein the battery is a lithium ion secondary battery having a prismatic shape.
